(19) United States
(12) Patent Application Publication
(10) Pub. No.: US 2020/0030885 A1
(43) Pub. Date: Jan. 30, 2020

(54) CUTTING INSERT COOLING DEVICE

(71) Applicant: KORLOY INC., Seoul (KR)

(72) Inventors: Jae Yeong MUN, Cheongju-si, Chungcheongbuk-do (KR); Byung Hoon MIN, Cheongju-si, Chungcheongbuk-do (KR); Sang Yong LEE, Cheongju-si, Chungcheongbuk-do (KR); Young Nam CHOI, Cheongju-si, Chungcheongbuk-do (KR); Sun Yong AHN, Cheongju-si, Chungcheongbuk-do (KR); Young Heum KIM, Cheongju-si, Chungcheongbuk-do (KR)

(73) Assignee: KORLOY INC., Seoul (KR)

(21) Appl. No.: 16/604,099

(22) PCT Filed: Mar. 14, 2018
(86) PCT No.: PCT/KR2018/002958

§ 371 Date: Oct. 9, 2019

(30) Foreign Application Priority Data
May 16, 2017 (KR) 10-2017-0060453

(51) Int. Cl. B23B 27/10; B23B 27/16

(52) U.S. Cl. CPC B23B 27/10; B23B 2270/24; B23B 2250/12; B23B 27/1611

(57) ABSTRACT

The technical objective of the present invention is to provide a cutting insert cooling device capable of easily mounting a spraying member to a cutting tool while preventing the rotation thereof and eliminating the risk of losing a screw. To this end, the cutting insert cooling device according to the present invention, capable of spraying cooling water toward the cutting insert coupled to the cutting tool, comprises: a head part which forms the terminal end portion of the cutting tool and has a cooling water guide flow path part, and to which the cutting insert is coupled; a spraying member having a cooling water spouting flow path part to spray, toward the cutting insert, the cooling water guided through the cooling water guide flow path part; and an attaching and detaching unit that slides the spraying member to the head part so as to attach and detach the same.

### TECHNICAL FIELD

The present disclosure relates to a cutting insert cooling device capable of spraying cooling water toward a cutting insert.

### BACKGROUND ART

Generally, a cutting insert is coupled to a cutting tool mounted on a machine tool and is used for machining a workpiece made of iron, non-ferrous metal, non-metal material, and the like.

When the heat-resistant alloy (Ti-, Ni-, Co-based alloy) is used as the workpiece, unlike the common steel, cast iron or stainless steel, there occurs a problem of high heat and high melting in the cutting insert, which reduces the life of the cutting insert.

In order to solve such a problem, in the related art, a cutting tool is disclosed in Korean Patent Publication No. 10-2011-0117681, which includes, as shown in FIG. 6, a coolant conveying member 34 for conveying the coolant fluid to the cutting zone, and one or more screws 42 for mounting the coolant conveying member 34 to the head part 20 of the cutting tool body. It is also disclosed that the coolant conveying member 34 is integrally provided with the head part 20.

However, the related cutting tool has a problem that, when the coolant conveying member is integrally provided with the head, the entire cutting tool needs to be replaced when the coolant conveying member is out of order, which leads to an excessive replacement cost. In addition, when the coolant conveying member is mounted to the head part using a single screw, there is a problem that the coolant conveying member may be rotated about the screw at the head, and since the screw needs to be detached in a completely loosened state, there is a problem that the screw may be lost and mounting takes a long time. In addition, when the coolant conveying member is mounted to the head part using two screws, since the two screws need to be detached in a completely loosened state, there is a problem that the screws may be lost and mounting takes a long time.

### DETAILED DESCRIPTION OF INVENTION

### Technical Problem

The technical objective of the present disclosure is to provide a cutting insert cooling device capable of easily mounting a spraying member to a cutting tool while preventing the rotation thereof and eliminating the risk of losing a screw.

Another technical objective of the present disclosure is to provide a cutting insert cooling device capable of maintaining cooling water finally ejected from the spraying member in a straightforward state toward a cutting edge of the cutting insert.

Another technical objective of the present disclosure is to provide a cutting insert cooling device capable of supplying the cooling water finally ejected from the spraying member to a main cutting edge and a sub-cutting edge of the cutting insert, respectively.

Still another technical objective of the present disclosure is to provide a cutting insert cooling device capable of securing sealing between a cooling water guide flow path part of the cutting tool, and a cooling water spouting flow path part of the spraying member.

### Technical Solution

In order to achieve the above object, the cutting insert cooling device according to the embodiment of the present disclosure, capable of spraying the cooling water toward the cutting insert coupled to the head part of the cutting tool, includes: a cooling water guide flow path part formed in the head part, a spraying member in which a cooling water spouting flow path part is formed to spray, toward the cutting insert, the cooling water that is guided through the cooling water guide flow path part, and an attaching and detaching unit that slides the spraying member to the head part so as to attach and detach the same.

The attaching and detaching unit may include a guide groove elongated in the head part, and a protrusion slider slidably connected to the guide groove, in which the guide groove may have a wedge shape that gradually increases in width as a depth thereof increases, and the protrusion slider may have a wedge shape that gradually increases in width along a direction of protruding so as to correspond to the shape of the guide groove.

The guide groove may be placed perpendicularly to a longitudinal direction of the cooling water spouting flow path part.

The attaching and detaching unit may further include a screw locking groove recessed in one side of the spraying member and having a fixing rib protruding on an inner peripheral surface thereof, and a screw coupled to the head part and locked into the screw locking groove when the spraying member is slid in a direction of being mounted, in which, while the screw is loosely screwed to the head part, when the spraying member is slid in a mounting direction thereof so that the screw is locked in the screw locking groove, the attaching and detaching unit may connect the fixing rib to the head part by tightening the screw.

The cooling water spouting flow path part may include a cooling water inlet having a single flow path connected to the cooling water guide flow path part, and a nozzle part in fluid communication with the cooling water inlet and including first and second cooling water spouting path parts for ejecting the cooling water.

The cutting insert may include a corner cutting edge positioned at a distal end of the head part, a main cutting edge positioned on one side with reference to the corner cutting edge, and a sub-cutting edge positioned on the other side with reference to the corner cutting edge, in which the cooling water passed through the first cooling water spouting path part may be ejected toward the main cutting edge and the cooling water passed through the second cooling water spouting path part may be ejected toward the sub-cutting edge.

The shortest distance between the nozzle and the corner cutting edge may be set to 7 mm or less.

The cutting insert may have a rhombus shape with first and second diagonal lengths different from each other, in which the first diagonal length may be longer than the second diagonal length, the cooling water spouting flow path part may be formed in a direction of the first diagonal length, and the spraying member may be slid in the direction of the second diagonal length to be attached to and detached from the head part.

The cooling water spouting flow path part may include a cooling water inlet having a single flow path connected to the cooling water guide flow path part, and a nozzle part in fluid communication with the cooling water inlet and including first and second cooling water spouting path parts for ejecting the cooling water, in which a position of the screw may be set such that, when the spraying member is mounted on the cutting tool and the screw locking groove is locked with the screw, the cooling water passed through the first cooling water spouting path part of the spraying member is ejected toward a main cutting edge of the cutting insert, and the cooling water passed through the second cooling water spouting path part is ejected toward a sub-cutting edge of the cutting insert.

The cutting insert cooling device according to an embodiment of the present disclosure described above may further include a sealing member provided between the cooling water guide flow path part and the cooling water spouting flow path part.

### Advantageous Effects of the Invention

As described above, the cutting insert cooling device according to an embodiment of the present disclosure may have the following effects.

According to an embodiment of the present disclosure, a technical configuration is provided, which includes a head part, a spraying member, and an attaching and detaching unit, in which the attaching and detaching unit slides the spraying member on the head part to attach to and detach from the same, so that without requiring the screw as the main component for the attachment and detachment purposes, it is possible to easily mount the spraying member to the cutting tool while preventing the rotation thereof and eliminating the risk of losing a screw, unlike the related art that uses the screw as the main component.

Further, according to the embodiment of the present disclosure, the distance between the end of the nozzle part of the spraying member and the corner cutting edge of the cutting insert is set to 7 mm or less, so that the distance is relatively shorter compared to the related techniques. Accordingly, it is possible to maintain the cooling water finally ejected from the spraying member in a straightforward state toward the cutting edge of the cutting insert, and thus improve the cooling efficiency for the cutting insert.

Further, according to the embodiment of the present disclosure, the nozzle part includes the first and second cooling water spouting path parts, so that the cooling water finally ejected from the spraying member can be respectively supplied to the main cutting edge and the sub-cutting edge of the cutting insert that are directly involved in cutting, thereby further improving the cooling efficiency for the cutting insert.

Further, according to the embodiment of the present disclosure, the sealing member is provided between the cooling water guide flow path part and the cooling water spouting flow path part. Accordingly, with the tight contact provided by the sealing member, it is possible to prevent the leakage of the cooling water between the flow path parts.

### BRIEF DESCRIPTION OF THE DRAWINGS

FIG. 1 is a perspective view schematically showing a state in which a cutting insert cooling device according to an embodiment of the present disclosure is provided on a head part of a cutting tool.

FIG. 2 is an exploded perspective view schematically showing a state in which a spraying member is detached from the head part of the cutting insert cooling device of FIG. 1.

FIG. 3 is a view showing a process in which the spraying member is slid on the head part to be mounted thereon.

FIG. 4 is a view showing a state in which the spraying member is mounted on the head part.

FIGS. 5A and 5B are a side view and a plan view of the spraying member, schematically showing a cooling water spouting flow path part of the spraying member.

FIG. 6 is a view showing a state in which a coolant conveying member is mounted on the related cutting tool.

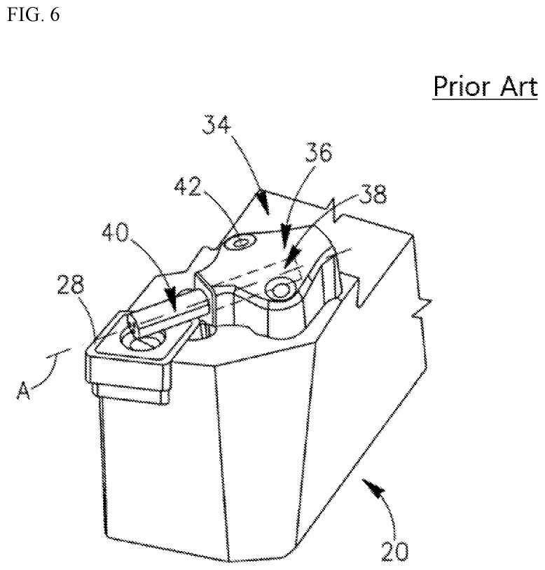

### DETAILED DESCRIPTION

Hereinafter, preferred embodiments of the present disclosure will be described in detail with reference to the accompanying drawings, which will be readily apparent to those skilled in the art to which the present disclosure pertains. However, the description proposed herein is just a preferable example for the purpose of illustrations only, and not intended to limit the scope of the disclosure, and accordingly, it should be understood that other equivalents and modifications could be made thereto without departing from the scope of the disclosure.

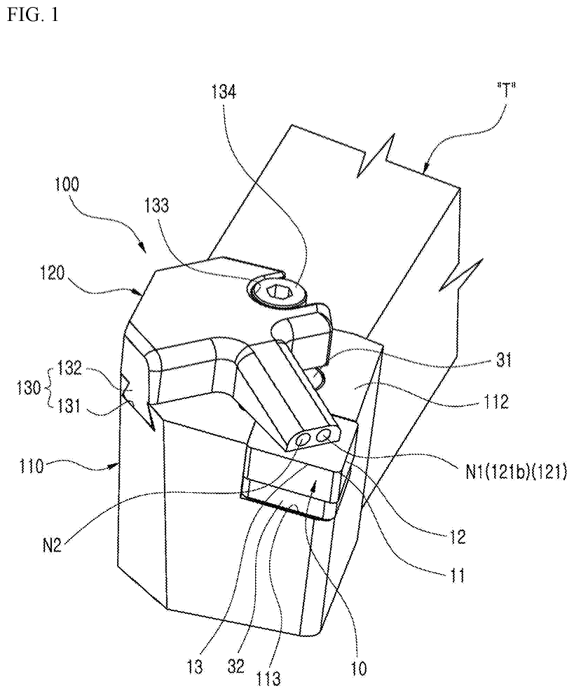

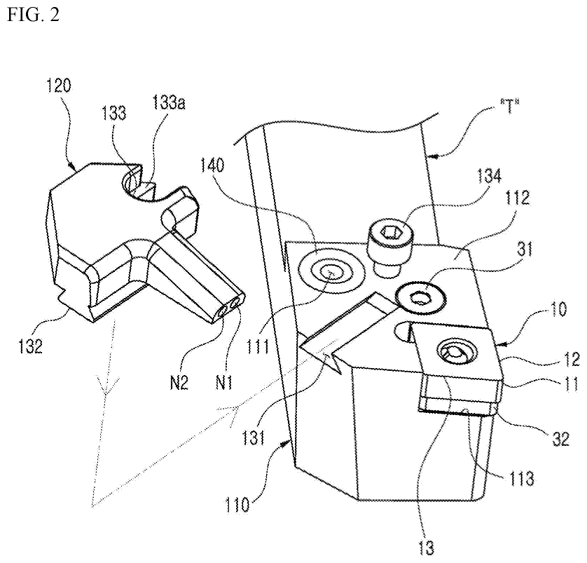

FIG. 1 is a perspective view schematically showing a state in which a cutting insert cooling device according to an embodiment of the present disclosure is provided on a head part of a cutting tool, and FIG. 2 is an exploded perspective view schematically showing a state in which a spraying member is detached from the head part of the cutting insert cooling device of FIG. 1.

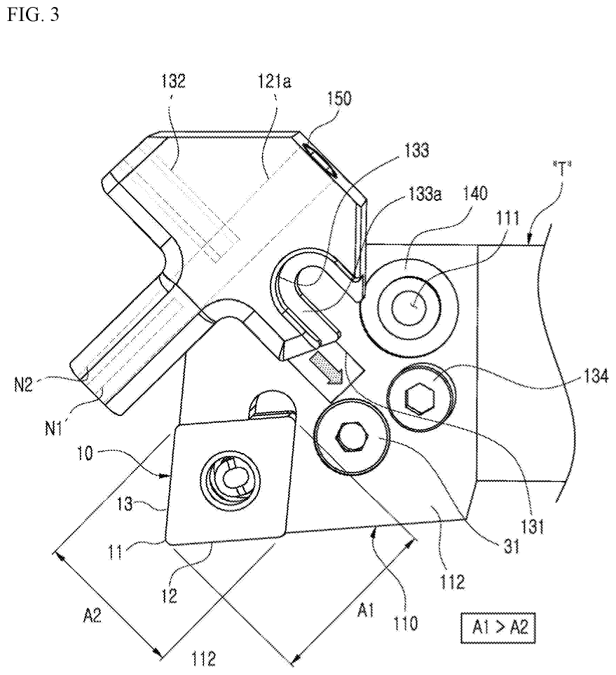

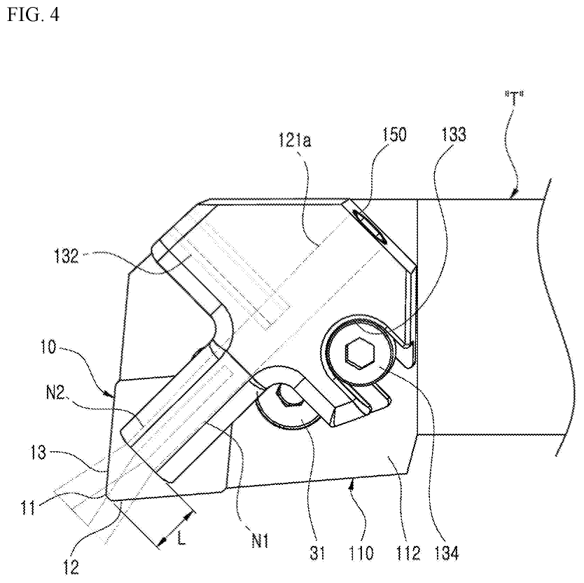

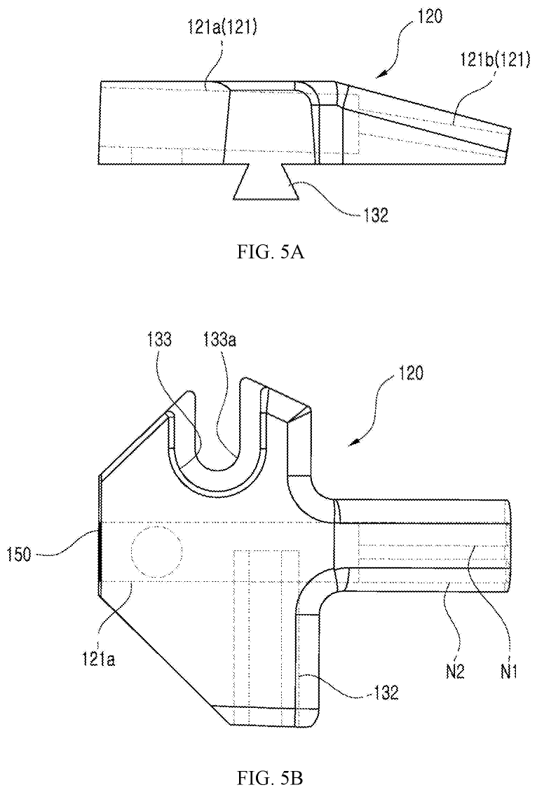

FIG. 3 is a view showing a process in which the spraying member is slid on the head part to be mounted thereon, FIG. 4 is a view showing a state in which the spraying member is mounted on the head, and FIGS. 5A and 5B are a side view and a plan view of the spraying member, schematically showing a cooling water spouting flow path part of the spraying member.

The cutting insert cooling device 100 according to an embodiment of the present disclosure is a cutting insert cooling device capable of spraying cooling water toward a cutting insert 10 coupled to a head part 110 of a cutting tool T, and includes a cooling water guide flow path part 111, a spraying member 120, and an attaching and detaching unit 130, as shown in FIGS. 1 to 5. Hereinafter, referring to FIGS. 1 to 5, each component will be described in detail.

The cooling water guide flow path part 111 is a component provided to guide the external cooling water to the spraying member 120, and may be formed in the head part 110 as shown in FIGS. 2 and 3. Here, as shown in FIGS. 1 to 4, the head part 110 forms a terminal end portion of the cutting tool T, to which the cutting insert 10 is coupled.

Furthermore, the head part 110 may include a planar portion 112 and a seat groove 113, as shown in FIGS. 2 and 3. The planar portion 112 is provided with a lever lock bolt 31 and the like for finally fixing the cutting insert 10, and may, together with the seat groove 113, serve as a holder for holding the cutting insert 10. The seat groove 113 may form an end portion of the head part 110, may be stepped from the planer portion 112, and the cutting insert 10 may be mounted therein. For example, when the cutting insert 10 together with a shim 32 is mounted on the seat groove 113, a first surface of the cutting insert 10 facing the spraying member 120 may be at the same height as the planar portion 112. For reference, the shim 32 may serve to protect the head part 110 of the cutting tool T when the cutting insert 10 is broken during processing.

As illustrated in FIG. 4, the spraying member 120 is a component provided to spray, toward the cutting insert 10, the cooling water guided through the cooling water guide flow path part 111. In particular, as shown in FIGS. 1 and 5, the cooling water flow path part 121 is formed in the spraying member 120.

For example, as illustrated in FIG. 5, the cooling water spouting flow path part 121 may include a cooling water inlet 121a and a nozzle part 121b. The cooling water inlet 121a is a single passage type and may be connected to the cooling water guide flow path part 111 of the head part 110, and the nozzle part 121b may be connected in fluid communication with the cooling water inlet 121a and may have first and second cooling water spouting path parts N1 and N2 for ejecting the cooling water. Furthermore, as shown in FIG. 5B, when viewed from above, the cooling water flow path part 121a and the first and second cooling water spouting path parts N1 and N2 may be disposed at the same height as each other, and as shown in FIG. 5A, when viewed from the side, the first and second cooling water spouting path parts N1 and N2 may be inclined downward with respect to the cooling water inlet 121a.

Furthermore, as shown in FIG. 5A, a bottom surface of the spraying member 120 may form a flat surface to be in contact with the planar portion 112 of the head part 110 and the first surface of the cutting insert 10 described above.

In addition, the shortest distance between the nozzle part 121b and the corner cutting edge 11 may be set to approximately 7 mm or less. Therefore, due to this relatively shorter distance compared to the related techniques, the cooling water finally ejected from the spraying member 120 can be maintained in the straightforward state toward the cutting edge 11 of the cutting insert 10, which can increase the cooling efficiency for the cutting insert 10.

In addition, as shown in FIGS. 1 to 4, when the cutting insert 10 includes a corner cutting edge 11 positioned at a distal end of the head part 110, a main cutting edge 12 positioned on one side with reference to the corner cutting edge 11, and a sub-cutting edge 13 positioned on the other side with reference to the corner cutting edge 11, as shown in FIG. 4, the cooling water passed through the first cooling water spouting path part N1 of the spraying member 120 described above may be ejected toward the main cutting edge 12, and the cooling water passed through the second cooling water spouting path part N2 of the spraying member 120 described above may be ejected toward the main cutting edge 13. Therefore, since the cooling water finally ejected from the spraying member 120 can be respectively supplied to the main cutting edge 12 and the sub-cutting edge 13 of the cutting insert 10 that are directly involved in the cutting, the cooling efficiency for the cutting insert 10 can be further increased. For reference, the corner cutting edge 11, the main cutting edge 12, and the sub-cutting edge 13 are well known techniques, and thus detailed description thereof will be omitted.

In addition, in the manufacturing process of the spraying member 120, after the cooling water spouting flow path part 121 is formed in the spraying member 120, a stopper 150 may be further provided in the spraying member to block the end of the cooling water spouting flow path part 121.

As shown in FIGS. 2 and 4, the attaching and detaching unit 130 is a component that slides the spraying member 120 so as to attach and detach it to and from the head part 110. By adopting the sliding type attaching and detaching unit 130, screws are not required as a main component for the attaching and detaching purposes, such that, unlike the related technology that uses the screw as the main component, it is possible to easily mount the spraying member to the cutting tool while preventing the rotation thereof and eliminating the risk of losing a screw.

For example, the attaching and detaching unit 130 may include a guide groove 131 and a protrusion slider 132, as shown in FIGS. 1 and 2. The guide groove 131 may be elongated in the planar portion 112 of the head part 110, and the protrusion slider 132 may be provided on a bottom surface of the spraying member 120 and slidably connected to the guide groove 131.

In particular, the guide groove 131 may have a wedge shape that gradually increases in width as the depth thereof increases, and the protrusion slider 132 may have a wedge shape that gradually increases in width along its protruding direction to correspond to the shape of the guide groove 131. Therefore, this wedge shape can prevent the phenomenon such as upward separation of the spraying member 120 and the like.

In addition, as shown in FIG. 3, the guide groove 131 may be placed perpendicularly to a longitudinal direction of the cooling water spouting flow path part 121. Accordingly, since the direction in which the spraying member 120 is slid is perpendicular to the direction in which the cooling water is ejected, it is possible to prevent the spraying member 120 from being separated even when the reaction force against the spouting pressure of the cooling water is applied to the spraying member 120.

Furthermore, the attaching and detaching unit 130 may further include a screw locking groove 133 and a screw 134, as shown in FIGS. 1 to 4. The screw locking groove 133 is formed to be recessed in the shape of an English alphabet “C” on one side of the spraying member 120 and a fixing rib (133a of FIG. 3) may protrude on an inner peripheral surface thereof, and the screw 134 may be coupled to the planar portion 112 of the head part 110, and positioned so to be locked into the screw locking groove 133 when the spraying member 120 is slid in a mounting direction thereof.

In particular, while the screw 134 is loosely screwed to the planar portion 112, when the spraying member 120 is slid in a mounting direction thereof so that the screw 134 is locked into the screw locking groove 133, the screw 134 can be tightened such that the fixing rib 133a can be connected to the planar portion 112. Therefore, unlike the related art in which the screw is completely unscrewed in order to achieve attachment and detachment, the attachment and detachment can be achieved in a state in which the screw 134 is loosely coupled, and accordingly, it is possible to easily mount the spraying member 120 to the cutting tool T without the risk of losing a screw 134.

Meanwhile, the positions of the screw locking groove 133 and the screw 134 may be determined such that the screw locking groove 133 is locked with the screw 134 at a position corresponding to where a front end of the protrusion slider 132 is locked with an end of the guide groove 131. Therefore, when the front end of the protrusion slider 132 is locked with the end of the guide groove 131, that is, when the spraying member 120 is moved until the protrusion slider 132 is completely slid into the guide groove 131, the screw locking groove 133 can be accurately positioned in the screw 134, thus facilitating the assembly. Alternatively, the position of the screw 134 may be set such that, when the screw locking groove 133 is locked with the screw 134 at the time of mounting the spraying member 120 to the cutting tool, as shown in FIG. 4, the cooling water passed through the first cooling water spouting path part N1 of the spraying member 120 is ejected toward the main cutting edge 12, and the cooling water passed through the second cooling water spouting path part N2 is ejected toward the sub-cutting edge 13, which results in an advantage that the user can accurately locate the fixing position when mounting the spraying member 120 to the cutting tool. At this time, any length of the guide groove 131 will suffice if the front end of the protrusion slider 132 is not locked with the end of the guide groove 131 until the screw locking groove 133 is locked with the screw 134.

In addition, as shown in FIG. 3, the cutting insert 10 may have a rhombus shape in which a first diagonal length A1 and a second diagonal length A2 are different from each other and the first diagonal length A1 may be longer than the second diagonal length A2.

In this particular case, the cooling water flow path part 121 may be formed in the direction of the first diagonal length A1, and the spraying member 120 may be slid in the direction of the second diagonal length A2 to be attached to or detached from the head part 110. Therefore, by the structure that slides in the direction of the second diagonal length A2, which is relatively shorter in length, the sliding distance can be minimized, and the attachment and detachment time can be further reduced.

In addition, as shown in FIG. 2, the cutting insert cooling device 100 according to an embodiment of the present disclosure described above may further include a sealing member 140 provided between the cooling water guide flow path part 111 and the cooling water spouting flow path part 121. Therefore, even when a sliding type attachment and detachment structure with a possibly weaker contact force between the members is used, it is possible to prevent leakage of the cooling water between the members, by the tight contact provided by the sealing member 140.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

### INDUSTRIAL APPLICABILITY

The present disclosure relates to a cutting insert cooling device capable of spraying cooling water toward a cutting insert, and thus has industrial applicability.

What is claimed is:

1. A cutting insert cooling device capable of spraying cooling water toward a cutting insert coupled to a head part of a cutting tool, comprising:
a cooling water guide flow path part formed in the head part;
a spraying member in which a cooling water spouting flow path part is formed to spray, toward the cutting insert, the cooling water that is guided through the cooling water guide flow path part; and
an attaching and detaching unit that slides the spraying member on the head part to attach and detach the same.

2. The cutting insert cooling device according to claim 1, wherein the attaching and detaching unit includes:
a guide groove elongated in the head part; and
a protrusion slider slidably connected to the guide groove, wherein the guide groove has a wedge shape that gradually increases in width as a depth thereof increases, and
the protrusion slider has a wedge shape that gradually increases in width along its protruding direction so as to correspond to the shape of the guide groove.

3. The cutting insert cooling device according to claim 2, wherein the guide groove is placed perpendicularly to a longitudinal direction of the cooling water spouting flow path part.

4. The cutting insert cooling device according to claim 2, wherein the attaching and detaching unit further includes:
a screw locking groove recessed in one side of the spraying member and having a fixing rib protruding on an inner peripheral surface thereof; and
a screw coupled to the head part and locked into the screw locking groove when the spraying member is slid in a direction of being mounted,
wherein, while the screw is loosely screwed to the head part, when the spraying member is slid in a mounting direction thereof so that the screw is locked in the screw locking groove, the attaching and detaching unit connects the fixing rib to the head part by tightening the screw.

5. The cutting insert cooling device according to claim 1, wherein the cooling water spouting flow path part includes:
a cooling water inlet having a single flow path connected to the cooling water guide flow path part; and
a nozzle part connected in fluid communication with the cooling water inlet, and including first and second cooling water spouting path parts for ejecting the cooling water.

6. The cutting insert cooling device according to claim 5, wherein the cutting insert includes:
a corner cutting edge positioned at a distal end of the head part;
a main cutting edge positioned on one side with reference to the corner cutting edge; and
a sub-cutting edge positioned on the other side with reference to the corner cutting edge,
wherein the cooling water that passed through the first cooling water spouting path part is ejected toward the main cutting edge, and
the cooling water that passed through the second cooling water spouting path part is ejected toward the sub-cutting edge.

7. The cutting insert cooling device according to claim 6, wherein the shortest distance between the nozzle part and the corner cutting edge is set to 7 mm or less.

8. The cutting insert cooling device according to claim 1, wherein the cutting insert has a rhombus shape with first and second diagonal lengths different from each other,
wherein the first diagonal length is longer than the second diagonal length,
the cooling water spouting flow path part is formed in a direction of the first diagonal length, and
the spraying member is slid in the direction of the second diagonal length to be attached to and detached from the head part.

9. The cutting insert cooling device according to claim 1, wherein the cutting insert cooling device further includes a sealing member provided between the cooling water guide flow path part and the cooling water spouting flow path part.

10. The cutting insert cooling device according to claim 4, wherein the cooling water spouting flow path part includes a cooling water inlet having a single flow path connected to the cooling water guide flow path part; and
a nozzle part in fluid communication with the cooling water inlet and including first and second cooling water spouting path parts for ejecting the cooling water,
wherein a position of the screw is set such that, when the spraying member is mounted on the cutting tool and the screw locking groove is locked with the screw, the cooling water that passed through the first cooling water spouting path part of the spraying member is ejected toward a main cutting edge of the cutting insert, and the cooling water that passed through the second cooling water spouting path part is ejected toward a sub-cutting edge of the cutting insert.
